(19) United States
(12) Patent Application Publication
(10) Pub. No.: US 2010/0303027 A1
(43) Pub. Date: Dec. 2, 2010

(54) METHOD FOR SENDING DATA PACKETS IN A DATA NETWORK DURING HANDOVER OF A MOBILE NODE

(75) Inventor: Alvaro Fernandez Gutierrez, Barcelona (ES)

Correspondence Address: BERENBAUM WEINSHIENK PC, 370 17TH STREET, SUITE 4800, DENVER, CO, 80202, US

(73) Assignee: MEDIA PATENTS, S.L., Barcelona (ES)

(21) Appl. No.: 12/594,190

(22) PCT Filed: Jun. 12, 2009
(86) PCT No.: PCT/EP2009/057309

§ 371 Date: Sep. 30, 2009

(30) Foreign Application Priority Data
Jun. 13, 2008 (ES) P 200801783

(51) Int. Cl. H04W 40/00

(52) U.S. Cl. 370/329

(57) ABSTRACT

A method and equipment for transmitting data packets in a data network originating from a mobile node. In one embodiment a method involves the mobile node transmitting immediately after a handover from a first router to a second router data packets having a source address that includes a local level 3 source address in the OSI model.

### FIELD OF THE INVENTION

The present invention relates to a process for use in a data network to transmit data packets between a first mobile node and a second node, and to equipment to carry out this process.

### BACKGROUND

Mobile IP is a set of protocols defined by the IETF that allows a mobile device that sends IP packets for communication to move and use different routers in different data networks as it is moving. The common term for referring to the mobile device is Mobile Node.

The two primary Mobile IP protocols are the protocols named Mobile IPv4 and Mobile IPv6, which use IPv4 type and IPv6 type IP addresses, respectively.

The protocol IP Mobility Support for IPv4 (hereinafter, Mobile IPv4) is described in specification RFC 3344 (Request for Comments 3344) published online by the IETF (Internet Engineering Task Force), C. Perkins, August 2002, currently available online at http://www.ietf.org./rfc/rfc3344.txt.

The protocol Mobility Support in IPv6 (hereinafter, MIPv6 or Mobile IPv6) is described in specification RFC 3775 published online by the IETF, D. Johnson et al., June 2004, currently available online at http://www.ietf.org/rfc/rfc3775.txt.

A very brief summary about how Mobile IP works is provided below.

A Mobile Node can have two IP addresses: a permanent address called “Home Address” and a changing address called “Care of Address” or “CoA”, which is an address associated with the network that the Mobile Node is visiting at a given moment.

A device called a “Home Agent” stores the information from the Mobile Node whose permanent IP address is on the same network as the Home Agent. When the Mobile Node is in its permanent network, it does not need to use mobile services.

When a network node, commonly called a “Correspondent Node”, wants to send IP packets to a Mobile Node that is on a remote network, it uses the permanent address of the Mobile Node, that is the Home Address, to send the IP packets. These IP packets are intercepted by the Home Agent, which encapsulates these packets by adding a new IP header and resends them through a tunnel to the CoA address of the remote network where the Mobile Node is located.

To encapsulate and send the packets through a tunnel, the Home Agent and the Mobile Node can use several protocols, such as the “IP Encapsulation within IP” protocol described in RFC 2003 published online by the IETF, Perkins et al., October 2003, currently available online at http://www.ietf.org/rfc/rfc2003.txt.

When a Mobile Node is located outside its permanent network and wants to send IP packets to a Correspondent Node, the Mobile Node can send them in a variety of ways, which are explained below.

One way that is common to both Mobile IPv4 and Mobile IPv6 is to encapsulate the packets that are going to the Correspondent Node and to first send them to the Home Agent through a tunnel so that the Home Agent resends them to the Correspondent Node. This procedure is called Reverse Tunneling and its use in Mobile IPv4 is described in RFC 3024, G. Montenegro, January 2001, currently available online at http://www.ietf.org/rfc/rfc3024.txt. Its use in Mobile IPv6 is described in section 11.3.1 of the aforementioned RFC 3775.

When the Mobile Node is located on a remote network, it can also send IP packets directly to the Correspondent Node in a variety of different ways without the IP packets going through the Home Agent.

In Mobile IPv4, a Mobile Node can send IP packets directly to the Correspondent Node using the Home Address as the source address of those packets. This causes a problem with data network routers that perform a function called ingress filtering, which ensures that the source address of the IP packets that are being transmitted match a correct network topology-based IP address.

Mobile IPv6 allows a Mobile Node to send IPv6 packets directly to the Correspondent Node without these packets going through the Home Agent, but only when the Mobile Node and the Correspondent Node have performed a registration process called binding. In this case, a procedure called route optimization is used that prevents the ingress filtering problem with the routers, a detailed description of which can be found in the aforementioned RFC 3375.

A process known as “handover” occurs when a Mobile Node changes from one router to another. When a Mobile Node moves from a first router to a second router, it is important that this change be performed as quickly as possible so as to prevent the Mobile Node from being unable to send or receive IP packets for a period of time (e.g., a few seconds). It is also important that IP packets arriving to the first router not be dropped when the Mobile Node is no longer connected. For example, in a voice over IP (VoIP) application, a several seconds latency or delay in sending and receiving packages is unacceptable.

To solve these problems associated with handover, the IETF has published two documents that propose different solutions. They are the documents named FHMIPv6 and HMIPv6 that are cited below.

The document “Fast Handover for Mobile IPv6” (FHMIPv6) is described in specification RFC 4068 published online by the IETF, R. Koodli, July 2005, currently available online at http://www.ietf.org/rfc/rfc4068.txt.

The document “Hierarchical Mobile IPv6 Mobility Management” (HMIPv6) is described in specification RFC 4140 published online by the IETF, H. Soliman et al., August 2005, currently available online at http://www.ietf.org/rfc/rfc4140.txt.

However, these two solutions to the problems that occur during the handover process are only partial solutions, and there continues to be a latency problem when a Mobile Node switches from one router to another. What is need is an improved handover process that reduces or minimizes the latency that occurs during this process.

### SUMMARY

A purpose of the invention is to provide an improved communications system in a data network containing mobile nodes.

In accordance with one embodiment, a procedure for use in a data network to transmit data packets between a first mobile node and a second node is provided wherein the first mobile node is connected to network equipment through a link and transmits data packets through the link and the data packets contain a level 3 destination address in the OSI model of a second node that is not connected to the link and a level 3 local source address in the OSI model. When the network equipment receives the data packets, the network equipment modifies the data packets by changing the local source address to a global source address and transmits the data packets with the global source address.

With this purpose, a procedure used in a data network has been developed to transmit data packets between a first mobile node which in one embodiment includes: a first mobile node connected to network equipment through a link, the first mobile node transmits data packets through the link, the data packets include a level 3 destination address in the OSI model of a second node that is not connected to the link, the data packets include a level 3 local source address in the OSI model, the network equipment receives the data packets transmitted by the mobile node, the network equipment modifies the data packets by changing the local source address of the data packets to a global source address, and the network equipment transmits the data packets with the said global source address. The data packets are preferably IP (Internet Protocol) packets. In one embodiment the data packets are IP version 6 packets.

In another embodiment method comprises the Mobile Node sending the data packets to the network interface of the network equipment by encapsulating the data packets in data frames that have a level 2 address corresponding to a level 3 multicast type address as their level 2 destination address. The level 3 multicast type address is preferably the address named ‘all routers multicast address’, which has the value FF02::2.

In accordance with another embodiment, a method for transmitting data packets in a data network comprises receiving in a network equipment via a data link a first data packet from a first mobile node, the first data packet comprising a source address and a destination address, the destination address being a level 3 destination address in the OSI model of a node not connected to the data link, the source address having a network portion and a host portion, the network portion comprising a link-local address network prefix different than the link-local address of the data link; and modifying in the network equipment the first data packet to produce a first modified data packet by replacing the link-local address network prefix with a first network prefix corresponding to the network to which the mobile node is connected.

In accordance with another embodiment, a method of transmitting data packets from a mobile node immediately after a handover of the mobile node from a first router to a second router is provided, wherein prior to the handover the mobile node transmitted data packets using a first Care-of-Address, the method comprising the mobile node transmitting through a data link to the second router data packets comprising a source address and a destination address, the destination address being a level 3 destination address in the OSI model of a node not connected to the data link, the source address having a network portion and a host portion, the network portion comprising a link-local address network prefix different than the link-local address of the data link.

In accordance with another embodiment, a method of transmitting data packets from a mobile node immediately after a handover of the mobile node from a first router to a second router is provided, wherein prior to the handover the mobile node transmitted data packets using a first Care-of-Address, the method comprising the mobile node transmitting through a data link to the second router data packets comprising a source address having a network portion and a host portion, the network portion comprising a link-local address network prefix different than the link-local address of the data link.

In accordance with yet another embodiment, a method for transmitting data packets in a data network is provided that comprises receiving in a network equipment via a data link a data packet from a mobile node, the data packet comprising a source address and a destination address, the destination address being a level 3 destination address in the OSI model of a node not connected to the data link, the source address including a local level 3 source address in the OSI model; and modifying in the network equipment the data packet to produce a modified data packet by replacing the local level 3 source address with a global source address.

In accordance with another embodiment, a method of transmitting data packets from a mobile node immediately after a handover of the mobile node from a first router to a second router is provided that comprises the mobile node transmitting through a data link to the second router data packets comprising a source address and a destination address, the destination address being a level 3 destination address in the OSI model of a node not connected to the data link, the source address including a local level 3 source address in the OSI model.

In accordance with another embodiment, a method of transmitting data packets from a mobile node immediately after a handover of the mobile node from a first router to a second router is provided that comprises the mobile node transmitting through a data link to the second router data packets comprising a first source address and a destination address, the source address including a local level 3 source address in the OSI model, the mobile node transmitting the data packets to the second router by encapsulating the data packets in data frames that have a level 2 address corresponding to a level 3 multicast type address as a level 2 destination address.

In accordance with yet another embodiment, network equipment in a data network is provided that stores executable instructions for 1) receiving via a data link a data packet from a mobile node, the data packet comprising a source address and a destination address, the destination address being a level 3 destination address in the OSI model of a node not connected to the data link, the source address having a network portion and a host portion, the network portion comprising a link-local address network prefix different than the link-local address of the data link and 2) modifying the data packet to produce a modified data packet by replacing the link-local address network prefix with a first network prefix corresponding to the network to which the mobile node is connected.

In accordance with another embodiment, network equipment in a data network is provided that stores executable instructions for 1) receiving via a data link a data packet from a mobile node, the data packet comprising a source address and a destination address, the destination address being a level 3 destination address in the OSI model of a node not connected to the data link, the source address including a local level 3 source address in the OSI model and, 2) modifying the first data packet to produce a first modified data packet by replacing the local level 3 source address with a global source address.

In accordance with another embodiment, a mobile node that generates and transmits data packets after a handover of the mobile node from a first router to a second router is provided, the mobile node storing executable instructions for 1) generating and transmitting immediately after the handover data packets that include a source address and a destination address, the destination address being a level 3 destination address in the OSI model of a node not connected to the data link, the source address including a local level 3 source address in the OSI model, and 2) upon receiving a new IP address from the second router generating and transmitting data packets using the new IP address as the source address in the data packets.

### BRIEF DESCRIPTION OF THE DRAWINGS

FIG. 1 illustrates an IP version 6 address.

FIG. 2 illustrates an IPv6 ‘link local’ address.

FIG. 3 illustrates a Mobile Node that sends IP packets to a first router in a data network.

FIG. 4 illustrates the Mobile Node of FIG. 3 connected to a second router in the data network.

FIG. 5 illustrates a transformation of an IP address in the second router in accordance with one implementation of the present invention.

### DETAILED DESCRIPTION

In accordance with alternative implementations, improved handover processes are provided in order to reduce the latency occurring in level 3 of the OSI model. As previously discusses, handover is the process that occurs when a Mobile Node that is connected to a first router switches its connection to a second router.

Handover latency is the delay in sending and receiving IP packets that affects the Mobile Node during the handover process. There are several reasons for this latency. There is a first latency at the data link level (level 2 of the OSI model) and a second latency at the network level (level 3 of the OSI model) where the IP protocol is running. The total latency is the sum of the level 2 latency and the level 3 latency.

Level 3 latency is caused by the need to obtain a new IP address from the new router, to verify that there is no other node using the new IP address in the new router, to send a registration request for this new IP address to the Home Agent, to wait for the Home Agent to authenticate the request and to wait for the Home Agent to send a response to the Mobile Node confirming that it can now begin to use the new IP address.

The present invention is aimed at reducing or eliminating the level 3 latency that occurs when the Mobile Node has to obtain a new IPv6 address. The way the Mobile Node obtains the new IPv6 address under the current state of the art is explained below.

In the IPv6 protocol, the way a new CoA address is obtained is described in section 11.5.2 “Forming New Care-of-Address” of the aforementioned specification RFC 3775. In IPv6, the Mobile Node can obtain the new IP address using two different procedures called “stateless” and “statefull”.

The first of these procedures is described in specification RFC 4862 “IPv6 Stateless Address Autoconfiguration”, S. Thomson et al., September 2007, currently available online at http://www.ietf.org/rfc/rfc4862.txt.

The second procedure is described in specification RFC 3315 “Dynamic Host Configuration Protocol for IPv6” (DHCPv6), R. Droms, et al., July 2003, currently available online at http://www.ietf.org/rfc/rfc3315.txt.

The first procedure, called “IPv6 Stateless Address Autoconfiguration”, is a faster procedure because the Mobile Node itself autoconfigures its IPv6 address without needing to use the services of a DHCP server. To that end, the Mobile Node only needs to find out the IPv6 prefix it has to use on the network connecting it to the router. A summary of this procedure is provided below. To that end, it is necessary to understand how the IPv6 addresses works.

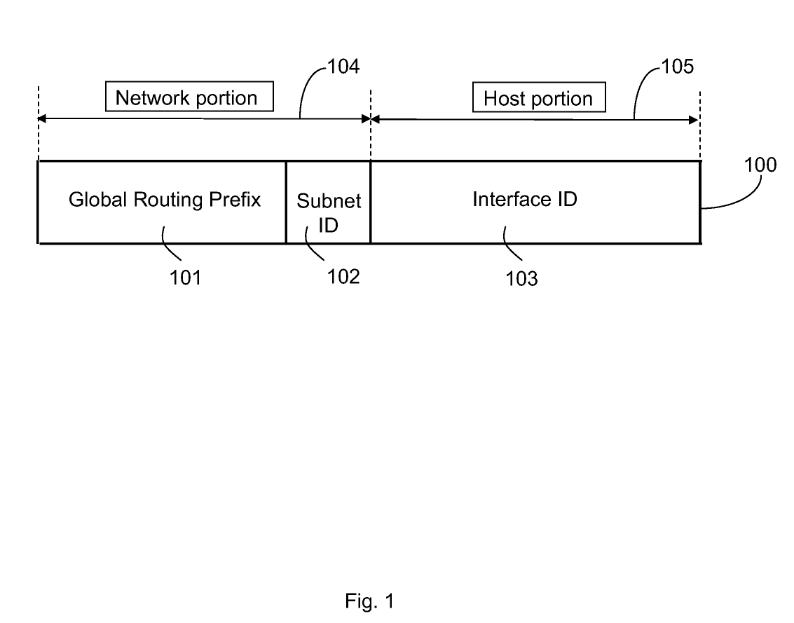

IPv6 addresses have 128 bits and are comprised of several parts. FIG. 1 illustrates a Global Unicast type IPv6 address 100, which are a global IPv6 addresses, meaning that they are unique and can be sent through routers over the Internet without needing to be modified. The first three bits of Global Unicast type IPv6 addresses have the value 001.

In Global Unicast type IPv6 addresses, there is a first part called Network Portion represented by arrow 104 in FIG. 1, which identifies the data network, and a second part called Host Portion, represented by arrow 105 in FIG. 1, which identifies an equipment or host network interface.

Usually, the part of the IPv6 address that identifies the host network interface is called Interface ID 103. Such an identifier is needed since a host can have more than one network interface. In addition, a host network interface can also have several IPv6 addresses and one additional IPv4 address.

In turn, the first part of the IPv6 100 address, which is called the Network Portion 104, is comprised of a first part called Global Routing Prefix 101 and a second part called Subnet ID 102.

The length of the Global Routing Prefix portion 101 is usually 48 bits, the length of the Subnet ID 102 is 16 bits and the length of the Interface ID 103 portion is 64 bits. However, this can vary. IPv6 addresses are described in specification RFC 4291 “IP Version 6 Addressing Architecture,” R. Hinden, et al., February 2006, currently available online at http://www.ietf.org/rfc/rfc4291.txt.

For a Mobile Node to be able to send IPv6 packets on a data network, it needs to know the prefix of the data network, which is the first 64 bits of its IPv6 address. The Mobile Node can obtain the data network prefix, and other information, by sending messages to the router to which it is connected and in response to the messages sent receive the information. The protocol used for this exchange of messages is described in specification RFC 4861 “Neighbor Discovery for IP version 6,” T. Narten, et al., September 2007, currently available online at http://www.ietf.org/rfc/rfc4861.txt.

In specification RFC 4861, the message the host sends to the router to request information is called Router Solicitation or RS. The messages that the router sends with information are called Router Advertisement or RA. A router can send RA messages periodically and also when asked to by a host through an RS message.

In the IPv6 Stateless Address Autoconfiguration procedure, the Mobile Node acquires one or more network prefixes through the RA messages it receives and also calculates the value of the Interface ID portion of its address so that this calculated value is unique. To do this, it can use several mechanisms described in the aforementioned RFC 4862, such as the mechanism called MAC-to-EU164. This mechanism uses the 48 bits of the MAC (Media Access Control) address of the network interface to calculate the 64 bits of the Interface ID. Since the 48 bits of the MAC address are theoretically different in each network interface that is manufactured, this mechanism allows to obtain a unique 64-bit Interface ID address for each network interface. A detailed explanation of 48 bits to 64 bits conversion is described in RFC 4862.

By adding the 64 bit prefix obtained from the RA message to the 64 bits of the Interface ID, the Mobile Node has a 128 bit Global Unicast Address IPv6 that is unique, and that way the Mobile Node can start sending IP packets using that IP address.

In this process of obtaining the new IPv6, the Interface ID calculation is almost instantaneous, and this value depends solely on the MAC address of each network interface of the Mobile Node and does not change when the Mobile Node change from routers.

However, to obtain the network prefix, the Mobile Node has to wait to receive an RA message from the router or send an RS message that the router has to process in order to send an RA message in response, and this process is not instantaneous and causes a latency while the Mobile Node and the router exchange and process the RS and RA messages.

The present invention reduces or eliminates this latency associated with obtaining the network prefix. To that end, the present invention uses a special IPv6 address called ‘link-local address’. This IP address called ‘link local address’ is formed of the network prefix called ‘link local’ and the Interface ID, and is used to send IP packets that are addressed to the same network link as the one the Mobile Node is connected to. Hence, its name: ‘link local address’.

The term ‘link’ used in data networks refers to a medium to facilitate communications that allows several nodes to communicate at level 2 of the OSI model, called ‘data link level’.

The network prefix called ‘link local’ is FE80::0, as expressed in common IPv6 protocol notation. The expression “::” represents a chain of zeros (in prefixes having a length of 64 bits, this prefix corresponds to the 8-byte prefix FE.80.00.00.00.00.00.00 in hexadecimal notation).

One way the ‘link local’ prefix FE80::0 is joined to the Interface ID to form the ‘link local’ IPv6 address may be as follows:

The bits to the left of the ‘link local’ IPv6 address are the bits of network prefix FE80::0.

The rest of the bits of the IPv6 address are filled in with zeros.

If the Interface ID is N bits long, the N bits to the right of the address are replaced with the bits of the Interface ID

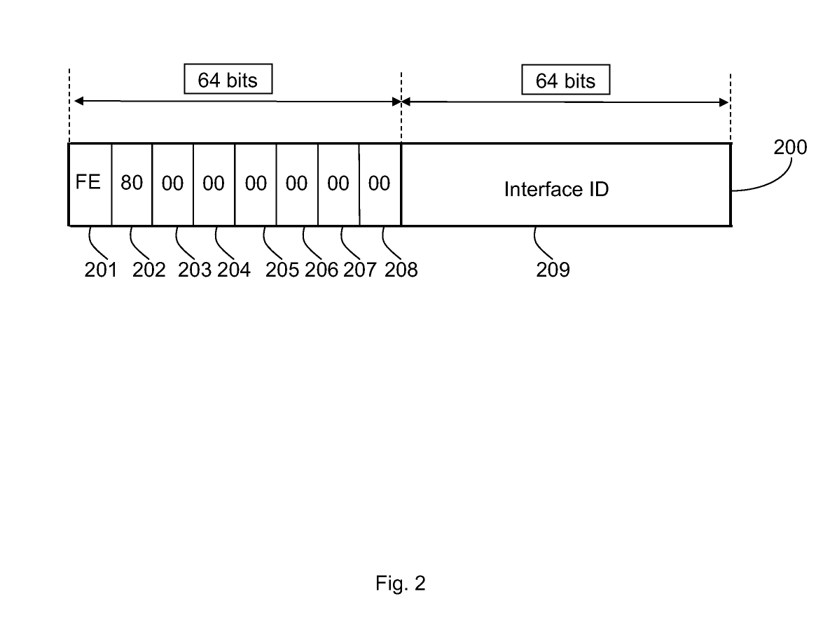

FIG. 2 illustrates a ‘link local’ type IPv6 address 200 in the most common situation, which is when the Interface ID portion 209 of the IPv6 address has an address that is 64 bits long. As illustrated, the network prefix comprising the 8-byte ‘link local’ denoted by reference numerals 201 through 208.

The present invention reduces or eliminates the latency associated with the process that the Mobile Node uses to obtain the new network prefix during handover by using the ‘link local’ address in a new way. Specifically, the Mobile Node sends IP packets whose IP source address is the ‘link local’ address and whose destination IP address corresponds to other network nodes that are not connected to the same link as the Mobile Node.

Thus, the Mobile Node uses the ‘link local’ address for an unexpected use, that is, to send IP packets to nodes that are not connected to the same link as its network interface.

A problem that arises is that the IP packets sent by the Mobile Node using the ‘link local’ address as the IP source address cannot be transmitted by the router to other routers because they do not have a correct IP source address identifying the Mobile Node. More specifically, in the IP source address of these IP packets is missing the network prefix that the network interface of the router uses to communicate with the Mobile Node. In one implementation of the present invention, although the Mobile Node has not yet received the information regarding the network prefix it should use, the Mobile Node sends the IP packets without the network prefix to a router. The router, which knows the network prefix, then modifies these IP packets by changing the IP source address of the IP packets to replace the prefix FE80::0 with the network prefix corresponding to the network to which the Mobile Node is connected.

In one embodiment, the router receiving the packet from the Mobile Node executes a process similar to the Network Address Translation that is used in IPv4 protocol to prevent the scarcity of IPv4 addresses. However, the router performs this address change with IPv6 type addresses. This causes a paradox to occur since a big advantage of using IPv6 addresses is that they do not require address modification, as previously discussed, since there is no problem with the scarcity of addresses in IPv6. The present invention, however, makes a new use of the address modification process in order to reduce or eliminate the latency associated with the Mobile Node obtaining the network prefix.

As a result, it is possible for the Mobile Node to send IP packets to other data network nodes instantaneously, or nearly instantaneously, by connecting to the new router even although the Mobile Node has not yet obtained the information about the data prefix it should use. Since the ‘link local’ IPv6 address calculation is essentially immediate, the Mobile Node can begin sending IP packages without the delay associated with the process of obtaining the network prefix.

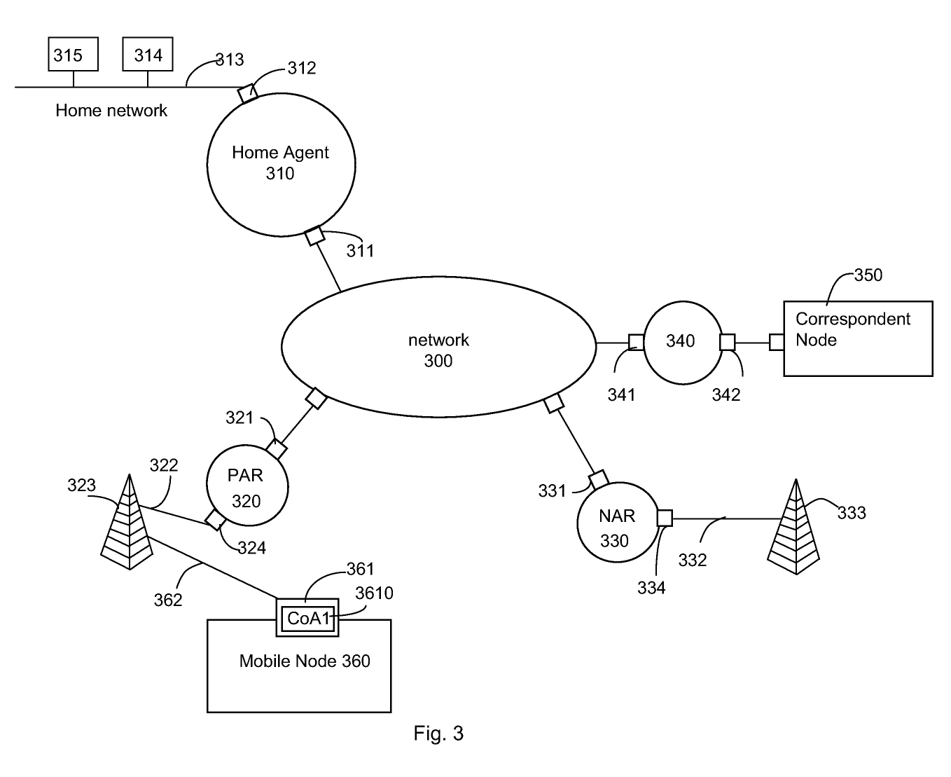

FIGS. 3, 4 and 5 illustrate such a process in one implementation of the present invention.

FIG. 3 shows a data network 300 connected to a router called Home Agent 310 and other routers 320, 330 and 340. The Home Agent 310 is connected to a home network 313 through network interface 312. Other nodes 314 and 315 may also be connected to the home network. All of these elements that are connected to the data network 300 can also be considered as part of the data network. The term data network may be used to refer to both the data network 300 and also to the network 300 along with all the other elements that send data packets over the network 300.

The router 320 is called PAR, which is an abbreviation for Previous Access Router. The router 330 is called NAR, an abbreviation for Next Access Router. These names are commonly used by some protocols related to Mobile IP protocols, such as the aforementioned FHMIPv6 protocol, and have been used in FIG. 3 for discussion purposes.

We will use the expression Mobile Node to refer to the mobile nodes of the network because it is the common term that all of the aforementioned RFCs use.

A Mobile Node 360 communicates wirelessly 362 through its network interface 361 with an antenna 323 that communicates with the network interface 324 of the PAR router 320.

In the example shown, the Mobile Node has registered the IP address 3610 of its network interface 361 in the Home Agent 310. The IP address 3610 is called CoA1 or Care of Address 1.

The Mobile Node 360 can communicate through Mobile IP protocols with a plurality of network nodes. In Mobile IP protocol terminology, these nodes are called Correspondent Nodes.

FIG. 3 shows a Correspondent Node 350 connected to the data network 300 through the router 340. The Mobile Node 360 and the Correspondent Node 350 can communicate between one another using Mobile IP protocols. To this end, they can send between themselves IP packets in several different ways. One way is to exchange IP packets through the Home Agent 310. Another way is for the Mobile Node 360 to directly send IP packets to the Correspondent Node, and the Correspondent Node to also send IP packets directly to the Mobile Node.

FIG. 3 shows a single Correspondent Node 350 for the sake of simplicity. It is appreciated, however, that there can be a plurality of Correspondent Nodes communicating with the Mobile Node, either directly or through the Home Agent 310.

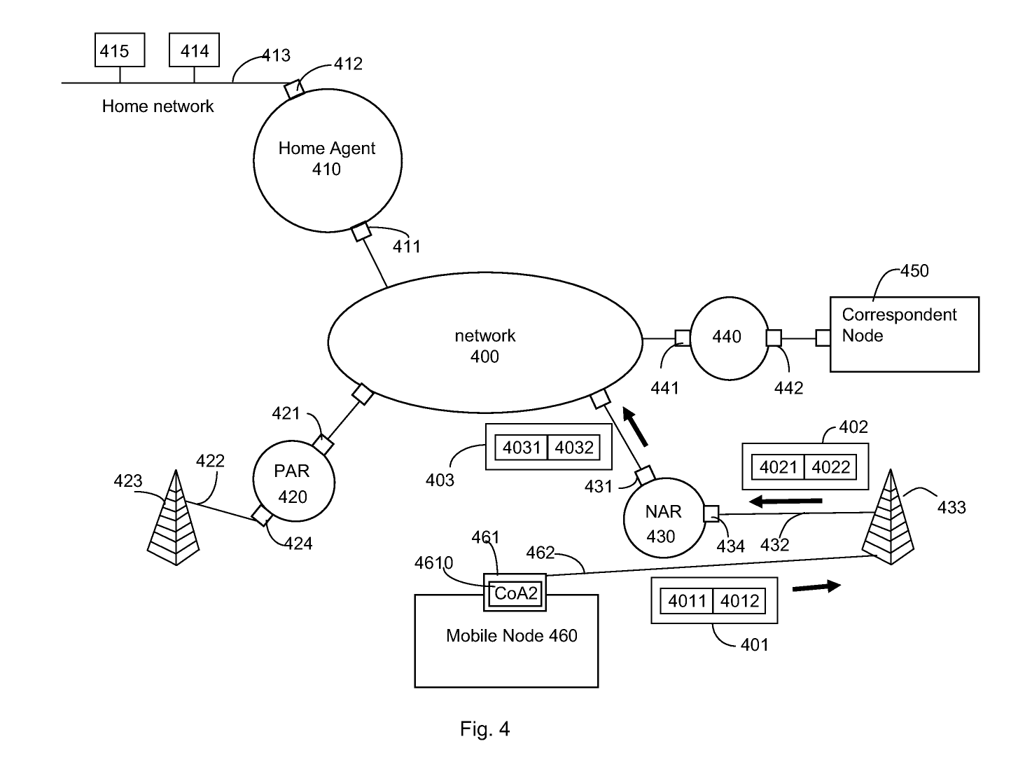

FIG. 4 shows the Mobile Node above, after the handover process to connect to the NAR router 430. The Mobile Node 460 must obtain and use a new IP address 4610 called CoA2 to send packets through the NAR router 430.

FIG. 4 shows an IP packet 401 that the Mobile Node 460 sends to other network nodes, for example, to the Home Agent 410 or to the Correspondent Node 450 before the Mobile Node 460 obtains the new CoA2 address. For simplicity, FIG. 4 shows a single IP packet 401, but the Mobile Node 460 can send a plurality of IP packets.

The IP packet 401 that Mobile Node 460 sends before it knows the network prefix is shown in FIG. 4 by elements 401, 402 and 403. Element 401 represents the IP packet leaving the network interface 461 of the Mobile Node 460.

Element 402 represents the IP packet when it arrives at the network interface 434 of the NAR router 430. Element 403 represents the IP packet when it leaves the network interface 431 of the NAR router 430.

These IP packets have an IP source address comprising at least two parts: the left part is the network prefix and the right part is the Interface ID. For example, the IP source address of the IP packet 401 comprises parts 4011 and 4012.

The parts to the right of the IP source address of packets 401, 402 and 403 are represented in FIG. 4 by elements 4012, 4022 and 4032, respectively. The right part of the IP source addresses is constant and contains the Interface ID value calculated by the Mobile Node.

When the IP packet 401 leaves the network interface 461 of the Mobile Node 460, the left part 4011 of its IP source address 401 contains the link local address network prefix described above. If the length of the prefix is 64 bits, this prefix will have the value FE.80.00.00.00.00.00.00 expressed in hexadecimal form. The IP packet 402 that arrives at the network interface 434 of the NAR router 430 has the same source IP address as the one that left the Mobile Node interface 461 and therefore the left part 4021 also contains the ‘link local’ address network prefix.

When the router 430 receives the IP packet 402 and detects that the IPv6 source address is a ‘link local’ address, for example because the IP source address uses the ‘link local’ network prefix, the router determines whether the IP packet 402 is headed to a network node connected to the same network link as the network interface 434, in which case it is customary to use the ‘link local’ address and it is the reason why this special address was created.

If the router 430 determines that the IP packet 402 is not headed to a node connected to the same link as the network interface 434, for example by analyzing the IP destination address of the IP packet 402, then the router modifies the left part 4021 of the IP source address of the IP packet 402 and transmits through its network interface 431 a packet 403 whose IP source address has in its left part 4031 a suitable network prefix for sending the packet 403 to the data network 400.

This way, even though the Mobile Node 460 does not yet know the network prefix it should use to form its new CoA2 address, the Mobile Node 460 can start sending IP packets, and the latency associated with obtaining the new CoA2 address is eliminated.

When the Mobile Node 460 completes the process of obtaining its new CoA2 address, either by using the stateless address autoconfiguration process or by using a DHCPv6 server, the Mobile Node 460 can begin sending IP packets using the new CoA2 address instead of using a ‘link local’ address, and it is no longer required that the NAR router 430 modify the IP source addresses of the IP packets it transmits that originate from Mobile Node 460.

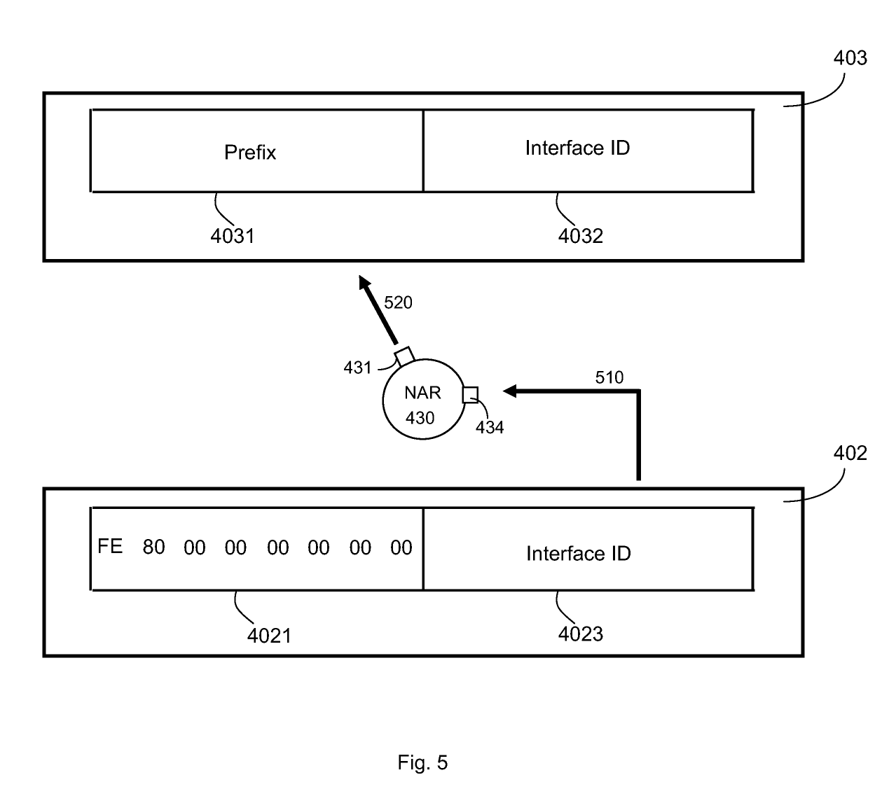

FIG. 5 illustrates, in one embodiment, the transformation of an IP packet when it passes through router 430.

Reference numeral 402 represents the IP packet sent by the Mobile Node 460 before it passes through the NAR router 430. IP packet 402 enters the NAR router 430 through the network interface 434. The IP packet 402 entering the NAR router 430 is represented by the arrow 510.

The IP source address of the IP packet 402 comprises the ‘link local’ prefix 4021 and the Interface ID 4023.

Reference numeral 403 represents the IP packet leaving the network interface 431 of the NAR router 430 going to the Home Agent 410 or to the Correspondent Node 450. The IP package 403 leaving the NAR router 430 is represented by the arrow 520.

The IP source address of the packet 403 comprises the network prefix 4031 and the Interface ID 4032.

FIG. 5 illustrates how the IP source address of the IP packet is modified when it passes through the NAR router 430, by replacing the ‘link local’ prefix with a new network prefix 4031 that together with the Interface ID 4032 forms a new Global Unicast type IPv6 address.

The NAR router 430 can choose the value of the network prefix 4031 of the source address of the IP packet 403 in different ways.

In one way, the prefix 4031 and the Interface ID 4032 is the same CoA2 address that the Mobile Node is going to use when it obtains the prefix 4031 later on, for example by a Router Advertisement message. This way, the IP packets that the NAR router 430 transmits already include the final CoA2 IPv6 address even though the Mobile Node 430 does not yet know the network prefix it has to use. This is possible, for example, if the NAR router 430 has a set of network prefixes and assigns them to different Mobile Nodes that request network prefix information using Router Solicitation messages. In one particular embodiment of the present invention, the NAR router 430 may assign a different network prefix to each Mobile Node, which is the customary way of assigning IPv6 addresses that use the standards defined by 3GPP and 3GPP2 workgroups dedicated to define mobile telephony standards.

In another way, the IPv6 source address of the packets comprises prefix 4031 and Interface ID 4032 and is a temporary IPv6 address different from the final CoA2 address. This temporary IPv6 address allows the Mobile Node 460 to send IP packets while it does not have the final CoA2 address. In this case, the IP packet 403 may include identifying data that permits the node to which the IP packet 403 is being sent to determine that the origin of packet 403 is from Mobile Node 460. Any data that uniquely identifies the Mobile Node 460 and that is known by the node to which the IP packet 403 is being sent can be used as an identifier. For example, the Interface ID itself, a Network Access Identifier (NAI), the Home Address of the Mobile Node 460 or even the CoA1 IPv6 address that the Mobile Node was previously using, can be used as identifiers.

For example, the Mobile Node 460 may encapsulate an IPv6 package by using the previous CoA1 address that it was using in the PAR router 420 as the source address of the IPv6 packet and send the encapsulated IPv6 packet to the router 430 using a ‘link local’ address. The NAR router 430 may then change the ‘link local’ source address of the IPv6 packet as explained in FIG. 5 and resend it to the Home Agent 410 so that the Home Agent removes the encapsulated IPv6 and resends the original packet to another network node. When the Home Agent 410 receives the IP packet 403, it can detect that it is coming from the Mobile Node 460 from any identifier that is unique to the Mobile Node 460, for example, the Interface ID or the previous CoA1 address, and resends that IP packet to the node of the network to which it is being sent. This way the Mobile Node 460 can continue using the old CoA1 address from the new NAR router 430 to send encapsulated IP packets to the Home Agent 410 while it does not have the new CoA2 address.

The process explained in the paragraph above may also be applied to encapsulated IP packets that the Mobile Node 460 sends directly to the Correspondent Node 450 using the procedure called Route Optimization, described in the aforementioned RFC 3775.

FIG. 4 also illustrates another aspect of the present invention when the Mobile Node 460 sends an IP packet to a network node that is not connected to communication links 432 and 462, such as an IP packet sent to the Correspondent Node 450, for example. In this case, the IP destination address of this IP packet will be the IP address of the Correspondent Node 450.

To send this IP packet to the interface 434 of the NAR router 430, the Mobile Node 460 encapsulates the IP packet in a level 2 data frame and the data frame includes enough information to reach the network interface 434 of the NAR router 430.

To simplify the explanation, we consider that the example in FIG. 4 uses Ethernet type technologies and that the communication between the Mobile Node 460 and the NAR router 430 uses 802.11 technology, also known as “WIFI”. However, other wireless communication technologies are equally useable in the present invention.

The Mobile Node 460 may encapsulate the IP packet being sent to the Correspondent Node 450 in a 802.11 type frame that uses the MAC address of the network interface 434 of the NAR router 430 as the destination address. The Mobile Node 460 may know the MAC address of the interface 434 of the NAR router 430 because it has obtained this information prior to or during the process of establishing the link 462. For example, section 6.3.7 of the aforementioned RFC 4861 describes how a Mobile Node can send Router Solicitation (RS) messages to several routers to obtain information before performing the handover process.

The problem occurs if the Mobile Node does not know the MAC address of the network interface 434 of the NAR router 430. In this case, the Mobile Node 460 cannot encapsulate the IP packet in a data frame with the MAC destination address of the network interface of the router.

To prevent this problem, in one embodiment of the present invention, the Mobile Node 460 sends the IP packet in a data frame to the network interface 434 using the same MAC address that it uses to send Router Solicitation messages as the MAC destination address of this data frame.

Section 4.1 “Router Solicitation Message Format” of specification RFC 4861 indicates that the IPv6 destination address of an RS message is the ‘link local’ all-routers multicast address. Section 2.3 “Addresses” of RFC 4861 indicates that the said address has the value FF02::2 in common IPv6 notation, which corresponds to the 16-byte value FF.02.00.00.00.00.00.00.00.00.00.00.00.00.00.02 in hexadecimal notation. The 64-bit MAC address corresponding to this 128-bit address is the address 33.33.00.00.00.02, as explained in section 7 of specification RFC 2464, “Transmission of IPv6 Packets over Ethernet Networks,” M. Crawford, December 1998, currently available online at http://ww.ietf.org/rfc/rfc2464.txt.

Therefore, even though the Mobile Node 460 does not know the MAC address of the network interface 434 of NAR router 430, it can send it a data frame that encapsulates the IP packet using the MAC address 33.33.00.00.00.02.

When the router 430 receives, through its network interface 434, the data frame transporting the IP packet that is being sent to the Correspondent Node 450, it checks that the IP destination address of the packet transporting the frame is not the address FF02::2, but rather a Global Unicast type IPv6 destination address and processes the IP packet to modify its IP source address before transmitting it through its network interface 431, as explained above. This way, the Mobile Node 460 may send data frames to the network interface 434 of the NAR router 430 even though it does not know the MAC address of that network interface 434.

Although the communication between the Mobile Node 460 and the NAR router 430 uses the IPv6 protocol, in an alternative implementation of the present invention, the Mobile Node 460, the NAR router 430, the Correspondent Node 450 and the Home Agent 410 can use different types of encapsulation for IP packets, such as IPv6 packets encapsulated in IPv4 packets, IPv4 packets encapsulated in IPv6 packets and IPv6 packets encapsulated in IPv6 packets. In this manner, the present invention also allows the Mobile Node 460 to communicate with nodes connected to the network 400 that uses the IPv4 protocol.

For example, the Mobile Node 460 can send to the Home Agent 410 IPv4 packets encapsulated in IPv6 packets that use a ‘link local’ type IPv6 source address while the Mobile Node 460 does not have the CoA2 address. When the IPv6 packets reach the NAR router 430, it modifies the source address as explained above and resends them to the Home Agent 410. When the Home Agent 410 receives the IPv6 packet, it removes the encapsulated IPv6 and sends the IPv4 packets through its network interface 411 to a node connected to the data network 400 that preferably uses IPv4 protocol.

In other embodiments of the present invention, the Mobile Node 460 determines the type of traffic associated with each IP packet and based on the type of traffic either sends the IP packets to the NAR router 430 before obtaining the new CoA2 address or waits to obtain the new CoA2 address before sending the IP packet to the NAR router 430.

For example, if the IP packet is transporting data from a protocol that uses voice over IP (VoIP), the Mobile Node 460 may send the IP packet without waiting to obtain the new CoA2 address, because the latency is important in voice communications.

In turn, if the IP packet is transporting data that are not affected by a latency of a few seconds, such as an e-mail for example, the Mobile Node 460 can wait to obtain the new CoA2 address before sending the IP packet.

In FIG. 3, elements 311, 312, 321, 331, 334, 341 and 342 identify the network interfaces of the Home Agent 310, PAR 320, NAR 330 and router 340, respectively. Elements 322 and 332 refer to a communication link between antennas 323 and 333 and routers 320 and 330 respectively. In FIG. 4, elements 400, 410-415, 420-424, 430-434, 440-442, 450 and 460 correspond to elements 300, 310-315, 320-324, 330-334, 340-342, 350 and 360 of FIG. 3, respectively.

What is claimed is:

1. A method for transmitting an IPv6 data packet in a router comprising:
receiving in a first interface of the router an IPv6 data packet, modifying an IPv6 address of the data packet and transmitting the modified data packet with the modified IPv6 address through a second interface of the router.

2. A method according to claim 1 wherein the modified IPv6 address is in the IPv6 header of the IPv6 data packet.

3. A method according to claim 2 wherein the modified IPv6 address is the source address.

4. A method for transmitting data packets in a data network comprising:
receiving in a network equipment via a data link a first data packet from a first mobile node, the first data packet comprising a source address and a destination address, the destination address being a level 3 destination address in the OSI model of a node not connected to the data link, the source address having a network portion and a host portion, the network portion comprising a link-local address network prefix; and
modifying in the network equipment the first data packet to produce a first modified data packet by replacing the link-local address network prefix with a first network prefix corresponding to the network to which the mobile node is connected.

5. A method according to claim 4 wherein the network equipment has a network interface for communicating with the mobile node, and wherein modifying the first data packet includes replacing the link-local address with the network prefix of the network interface of the network equipment.

6. A method according to claim 4 wherein the network equipment is a router.

7. A method according to claim 4 wherein at least a part of the host portion of the source address is derived from the Media Access Control address of the network interface of the mobile node.

8. A method according to claim 4 wherein the host portion of the source address is not modified by the network equipment.

9. A method according to claim 4 wherein the network equipment analyzes the destination address of the first data packet to determine that it is not of a node connected to the data link before replacing the link-local address network prefix.

10. A method according to claim 4 further comprising receiving in the network equipment via a data link a second data packet from a second mobile node, the second data packet comprising a source address and a destination address, the destination address being a level 3 destination address in the OSI model of a node not connected to the data link, the source address having a network portion and a host portion, the network portion comprising a link-local address network prefix; and
modifying in the network equipment the second data packet to produce a second modified data packet by replacing the link-local address network prefix with a second network prefix different from the first network prefix corresponding to the network to which the mobile node is connected.

11. A method according to any one of the preceding claims wherein the data packets are Internet Protocol (IP) packets.

12. A method according to any one of the preceding claims wherein the data packets are IP version 6 packets.

13. A method of transmitting data packets from a mobile node immediately after a handover of the mobile node from a first router to a second router, wherein prior to the handover the mobile node transmitted data packets using a first Care-of-Address, the method comprising:
the mobile node transmitting through a data link to the second router data packets comprising a source address and a destination address, the destination address being a level 3 destination address in the OSI model of a node not connected to the data link, the source address having a network portion and a host portion, the network portion comprising a link-local address network prefix.

14. A method according to claim 13 wherein at least a part of the host portion of the source address is generated by the mobile node from the Media Access Control address of the network interface of the mobile node.

15. A method according to claim 13 wherein the host portion of the source address includes one of the network interface ID of the first mobile node, a Network Access Identifier ????, the Home Address of the first mobile node, or the first Care-of-Address.

16. A method according to claim 13 further comprising the mobile node receiving a new Care-of-Address from the second router and terminates using the link-local address network prefix in the source address portions of the data packets.

17. A method according to claim 16 wherein the mobile node subsequently sends the data packets using the new Care-of-Address as the source address.

18. A method according to any one of claims 13-17 wherein the data packets are Internet Protocol (IP) packets.

19. A method according to any one of claims 13-18 wherein the data packets are IP version 6 packets.

20. A method for transmitting data packets in a data network comprising:
receiving in a network equipment via a data link a data packet from a mobile node, the data packet comprising a source address and a destination address, the destination address being a level 3 destination address in the OSI model of a node not connected to the data link, the source address including a local level 3 source address in the OSI model; and
modifying in the network equipment the data packet to produce a modified data packet by replacing the local level 3 source address with a global source address.

21. A method according to claim 20 wherein the network equipment is a router.

22. A method according any one of claims 20 and 21 wherein the data packets are Internet Protocol (IP) packets.

23. A method according to any one of claims 20-21 wherein the data packets are IP version 6 packets.

24. A method of transmitting data packets from a mobile node immediately after a handover of the mobile node from a first router to a second router comprising:
the mobile node transmitting through a data link to the second router data packets comprising a source address and a destination address, the destination address being a level 3 destination address in the OSI model of a node not connected to the data link, the source address including a link-local level 3 source address in the OSI model.

25. A method according to claim 24 further comprising the mobile node receiving a new IP address from the second router and begins using the new IP address as the source address in the data packets subsequently transmitted.

26. A method according to any one of claims 24 and 25 wherein the data packets are Internet Protocol (IP) packets.

27. A method according to any one of claims 24-26 wherein the data packets are IP version 6 packets.

28. A method of transmitting data packets from a mobile node immediately after a handover of the mobile node from a first router to a second router comprising:
the mobile node transmitting through a data link to the second router data packets comprising a source address and a destination address, the destination address being a level 3 destination address in the OSI model of a node not connected to the data link, the mobile node transmitting the data packets to the second router by encapsulating the data packets in data frames that have a level 2 multicast destination address corresponding to a level 3 multicast type address.

29. A method according to claim 28 wherein the level 3 multicast type address is the address named ‘all routers multicast address’, which has the value FF02::2.

30. A method according to any one of claims 28 and 29 wherein the data packets are Internet Protocol (IP) packets.

31. A method according to any one of claims 28-30 wherein the data packets are IP version 6 packets.

32. A network equipment in a data network storing executable instructions for 1) receiving via a data link a data packet from a mobile node, the data packet comprising a source address and a destination address, the destination address being a level 3 destination address in the OSI model of a node not connected to the data link, the source address having a network portion and a host portion, the network portion comprising a link-local address network prefix different than the network prefix of the data link and 2) modifying the data packet to produce a modified data packet by replacing the link-local address network prefix with a first network prefix corresponding to the network to which the mobile node is connected.

33. A network equipment in a data network storing executable instructions for 1) receiving via a data link a data packet from a mobile node, the data packet comprising a source address and a destination address, the destination address being a level 3 destination address in the OSI model of a node not connected to the data link, the source address including a link-local level 3 source address in the OSI model and, 2) modifying the first data packet to produce a first modified data packet by replacing the link-local level 3 source address with a global source address.

34. A mobile node that generates and transmits data packets after a handover of the mobile node from a first router to a second router, the mobile node storing executable instructions for 1) generating and transmitting immediately after the handover data packets that include a source address and a destination address, the destination address being a level 3 destination address in the OSI model of a node not connected to the data link, the source address including a local level 3 source address in the OSI model, and 2) upon receiving a new IP address from the second router generating and transmitting data packets using the new IP address as the source address in the data packets.

35. A method according to any one of claims 32-34 wherein the data packets are Internet Protocol (IP) packets.

36. A method according to any one of claims 32-35 wherein the data packets are IP version 6 packets.
